(19) United States
(12) Patent Application Publication
(10) Pub. No.: US 2025/0334817 A1
(43) Pub. Date: Oct. 30, 2025

(54) SMART GLASSES AND CONNECTING ASSEMBLY THEREOF

(71) Applicant: SOLOS TECHNOLOGY (SHENZHEN) LIMITED, Shenzhen (CN)

(72) Inventors: Chiu Ming So, Shenzhen (CN); Kwok Wah Law, Shenzhen (CN); Wai Kuen Cheung, Shenzhen (CN)

(21) Appl. No.: 19/256,269

(22) Filed: Jul. 1, 2025

Related U.S. Application Data
(63) Continuation-in-part of application No. 18/053,751, filed on Nov. 8, 2022, now Pat. No. 12,353,255.

(30) Foreign Application Priority Data
Feb. 18, 2022 (CN) 202210152566.0
Jul. 22, 2024 (CN) 202421742579.4

(51) Int. Cl. G02B 27/01

(52) U.S. Cl. CPC G02B 27/0176; G02B 27/0172; G02B 2027/0138; G02B 2027/0178

(57) ABSTRACT

Disclosed is a pair of smart glasses that includes frame, a left temple, a right temple and a connecting assembly, wherein the connecting assembly includes a connecting wire fixed onto the frame and a sensor unit being provided on the connecting wire. The connecting wire is configured with first and second smart hinges at two opposite ends thereof, respectively, the first smart hinge is configured for electrically connecting the left temple, and the second smart hinge is configured for electrically connecting the right temple. The sensor unit is electrically connected to the first smart hinge and/or the second smart hinge through the connecting wire.

### CROSS-REFERENCE TO RELATED APPLICATIONS

This application is a continuation-in-part application of application Ser. No. 18/053,751, filed on Nov. 8, 2022, which claims priority to Chinese Patent Application No. 202210152566.0, filed on Feb. 18, 2022, and claims priority to Chinese Patent Application No. 202421742579.4, filed on Jul. 22, 2024, the entire contents of which are hereby incorporated by reference.

### TECHNICAL FIELD

This application relates to the technical field of smart glasses, and in particular to a pair of smart glasses and a connecting assembly thereof.

### BACKGROUND

With the development of wearable technology, smart wearables, such as smart glasses, are used more widely. However, some questions need to be improved are also exposed during use.

For the existing smart glasses, various types of sensors are generally integrated on the frame/temple of the glasses, so as to achieve environmental perception and data collection. Such design has the advantage of good waterproof performance and is currently a commonly used design in the art. However, such design needs to provide accommodating space and related circuits in the frame/temple, resulting in a more complex structure and manufacturing process of the frame/temple of the glasses.

### SUMMARY

From above, the present application provides a pair of smart glasses and a connecting assembly thereof, aiming to solve the problem of complex structure and manufacturing process caused by integration of sensor(s) on the frame or the temple of the smart glasses.

In one aspect, embodiments of the present application provide a connecting assembly configured for setting on a frame of a pair of smart glasses to electrically connect left and right temples of the smart glasses, including:
a connecting wire being configured with first and second smart hinges at two opposite ends thereof, respectively, the first smart hinge being configured for electrically connecting the left temple, and the second smart hinge being configured for electrically connecting the right temple; and
a sensor unit being provided on the connecting wire and electrically connected to the first smart hinge and/or the second smart hinge through the connecting wire.

In some embodiments, the sensor unit is electrically connected to the connecting wire in a detachable manner.

In some embodiments, the sensor unit includes at least one sensor and a mechanical housing accommodating the at least one sensor therein.

In some embodiments, the connecting wire is electrically connected to the at least one sensor through welding, plugging, pressing or an electrical connector.

In some embodiments, a data transmission interface is provided on the mechanical housing and electrically connected to the at least one sensor, and a data transmission connector is provided at an end of the connecting wire and electrically connected to the data transmission interface through plugging.

In some embodiments, the connecting wire includes a first segment and a second segment, each of the first and second segments is provided with one data transmission connector, and the mechanical housing is provided with two data transmission interfaces;
one end of the first segment is electrically connected to the first smart hinge, and another end the first segment is connected to the mechanical housing; and
one end of the second segment is electrically connected to the second smart hinge, and another end of the second segment is connected to the mechanical housing.

In some embodiments, a wireless communication unit is provided inside the mechanical housing to transmit detected data of the sensor to a processor set in the first smart hinge, the second smart hinge, the left temple or the right temple.

In some embodiments, the sensor unit includes a sensor and an indicator light packaged as an integrated structure.

In some embodiments, the sensor unit includes at least one of a light sensor, a distance sensor, a gas sensor, an inertial sensor, a camera sensor and a sound sensor.

In another aspect, embodiments of the present application provide a pair of smart glasses that includes a frame, a left temple, a right temple and the above connecting assembly, wherein the connecting wire of the connecting assembly is fixed onto the frame, and the left temple and the right temple are electrically connected through the connecting wire.

In some embodiments, the frame is provided with a receiving groove, and the sensor unit is detachably installed in the receiving groove.

In some embodiments, the frame includes two accommodating parts and a bridge connected between the two accommodating parts, the receiving groove is defined at an inner side of the bridge, and an outer side of the bridge is provided with an external aperture at a position corresponding to the receiving groove; and the sensor unit comprises a distance sensor, wherein the distance sensor detects a distance information of a target object in the peripheral environment through the external aperture.

In some embodiments, the frame includes two accommodating parts and a bridge connected between the two accommodating parts, the receiving groove is defined at an inner side of the bridge, and an outer side of the bridge is provided with an external aperture at a position corresponding to the receiving groove; and the sensor unit comprises a light sensor, wherein the light sensor detects an ambient light information of the target object in the peripheral environment through the external aperture.

In some embodiments, the frame includes two accommodating parts and a bridge connected between the two accommodating parts, the receiving groove is defined at an inner side of the bridge, and an outer side of the bridge is provided with an external aperture at a position corresponding to the receiving groove; and the sensor unit comprises a camera sensor, wherein the camera sensor captures image of a target object in the peripheral environment through the external aperture.

In some embodiments, the sensor unit includes a temperature sensor, an open side of the receiving groove faces an inner side of the frame, and a cover is fixed onto the open side of the receiving groove, the cover is provided an internal aperture, and the temperature sensor detects an user's body temperature through the internal aperture.

In some embodiments, one end of the first smart hinge is configured to hinge with the frame, and another end of the first smart hinge is configured to achieve electrical connection with the left temple after being plugged in the left temple; and, one end of the second smart hinge is configured to hinge with the frame, and another end of the second smart hinge is configured to achieve electrical connection with the right temple after being plugged in the right temple.

In some embodiments, one end of the first smart hinge is configured to hinge with the frame, and another end of the first smart hinge is integrally connected to the left temple; and, one end of the second smart hinge is configured to hinge with the frame, and another end of the second smart hinge is integrally connected to the right temple.

Compared with the prior art, the present application has the following advantages:

The connecting assembly of the present application includes a connecting wire with a sensor unit, a first smart hinge, and a second smart hinge provided thereon. The sensor unit is electrically connected to the first smart hinge and/or the second smart hinge through the connecting wire. The first smart hinge is electrically connected to the left temple and the second smart hinge is electrically connected to the right temple, thereby achieving electrical connection between the sensor unit and the left and/or right temple. Data collected by the sensor unit can be transmitted to the left and/or right temple processing. Due to the fact that the space and structure required for installing the sensor unit are set on the connecting wire, only the structure for fixing the connecting wire needs to be set on the frame. It can be seen that by integrating the sensor unit and its related installation structures required for smart glasses into the connecting wire, this application can simplify the structure and manufacturing process of the frame or temples of the smart glasses.

### BRIEF DESCRIPTION OF THE DRAWINGS

In order to illustrate technical solutions of embodiments of the present application more clearly, drawings that need to be used in the description of the embodiments will be briefly described below. It is obvious that the drawings described below are only some embodiments of the present application, and other drawings may be obtained from the drawings without any creative work to those skilled in the art, which should be in the scope of this application. In the following description, the same reference numerals refer to the same members.

FIG. 1 is a schematic, exploded view of a pair of smart glasses provided by an embodiment of the present application.

FIG. 2 is a schematic, assembled view of the smart glasses of FIG. 1.

FIG. 3 is a schematic view of a connecting assembly provided by an embodiment of the present application, wherein it is assembled onto a frame of the smart glasses.

FIG. 4 is a schematic view of the connecting assembly of FIG. 3.

FIG. 5 is a schematic view of the frame of FIG. 3, in which a cover is removed.

FIG. 6 is a schematic view of the frame, in which a connecting wire of the connecting assembly is covered.

FIG. 7 is a schematic view of a smart hinge and a temple of the smart glasses with a sealing ring provided by an embodiment of the present application, which are before assembly.

FIG. 8 is a schematic view of the smart hinge and the temple of the smart glasses with the sealing ring provided by an embodiment of the present application, which are assembled.

FIG. 9 is a schematic view of the connecting wire, a circuit board and a substrate of the smart hinge provided by an embodiment of the present application, wherein the connecting wire and the circuit board are welded to the substrate.

FIG. 10 is a schematic view of the connecting wire, the circuit board and the substrate provided by an embodiment of the present application, which are before assembly.

FIG. 11 is a schematic view of the smart hinge and the frame of the smart glasses provided by an embodiment of the present application, which are before assembly.

FIG. 12 is a schematic view of the temple of the smart glasses provided by an embodiment of the present application, which is connected to a corresponding type of external charging cable for charging a rechargeable battery inside the temple.

FIG. 13 is a schematic, exploded view of a pair of smart glasses provided by an alternative embodiment of the present application.

FIG. 14 is a schematic view of a connecting assembly of the smart glasses of FIG. 13.

FIG. 15 is a schematic view of a sensor unit of the connecting assembly of FIG. 14.

FIG. 15a a schematic view of a connecting assembly according to a second embodiment.

FIG. 16 is a schematic, exploded view of the connecting assembly and a frame of the smart glasses of FIG. 13.

FIG. 17 is a front view of the frame of the smart glasses of FIG. 13.

FIG. 18 is a schematic view of a connecting assembly according to third embodiment.

FIG. 19 is a schematic view of a connecting assembly according to a fourth embodiment.

Reference numbers in the accompanying drawings:
1/1h, frame; 11/11h, elongated slot; 12h, receiving groove; 13h/13i, receiving parts; 14h, bridge; 15h, external aperture; 16h, cover; 17h, internal aperture;
2, temple; 2a/2h, left temple; 2b/2i, right temple; 2j, contact; 21a, left connector; 21b, right connector; 22, latching groove;
3/3h/3h′/3h″, connecting assembly; 3a, first connector; 3b, second connector; 3c/30h/30h′/30h″, connecting wire; 3d, sealing cover; 301h, data transmission connector;
31h/31h′/31m, first segment; 32h/32h′/32m, second segment; 33h/33h″, sensor unit; 34h, mechanical housing; 341h, data transmission interface; 343h, transparent hole; 35h/35m, sensor; 36h/36m, circuit board; 37h, wireless communication unit; 38h, indicator light;
33m, first gold finger; 34m, second gold finger; 38m/39m, edge connectors;
4a/4h, first smart hinge; 4b/4i, second smart hinge; 4j, electrical contact; 41, insulating shell; 411, connecting hole; 413, latching portion; 42, circuit board; 43, substrate;
5, screw rod;
6, protruding ring;
7a/7b, anticollision groove; and
8, external charging cable.

### DESCRIPTION OF THE EMBODIMENTS

For better illustrating the technical means, creative features, objects and effects of the present application, detailed description will be given for the embodiments provided by the present application with reference to the append drawings. Obviously, the described embodiments are only a part of the embodiments, and not all of the embodiments of the present application. Based on the embodiments of the present application, all other embodiments obtained by those skilled in the art without any creative work should be in the scope of this application.

It should be noted that when an element is referred to as being “fixed to” or “disposed in/at” another element, it may be directly or indirectly on the other element. When an element is referred to as being “connected to” another element, it may be directly or indirectly connected to the other element.

It should be understood that oriental or positional relationships indicated by terms “length”, “width”, “upper”, “lower”, “front”, “rear”, “left”, “right”, “vertical”, “horizontal”, “top”, “bottom”, “inner”, “outer” and the like are only intended to facilitate the description of the present disclosure and simplify the description based on oriental or positional relationships shown in the accompanying drawings, not to indicate or imply that the apparatus or element referred must have a specific orientation, is constructed and operated in a specific orientation, and therefore cannot be understood as a limitation of the present disclosure.

In addition, terms “first” and “second” are only used for descriptive purposes, and cannot be understood as indicating or implying relative importance or implicitly indicating the number of technical features indicated. Therefore, features defined with “first” and “second” may explicitly or implicitly include one or more of these features. In the description of the present disclosure, “a plurality of” refers to two or more than two, unless otherwise particularly defined.

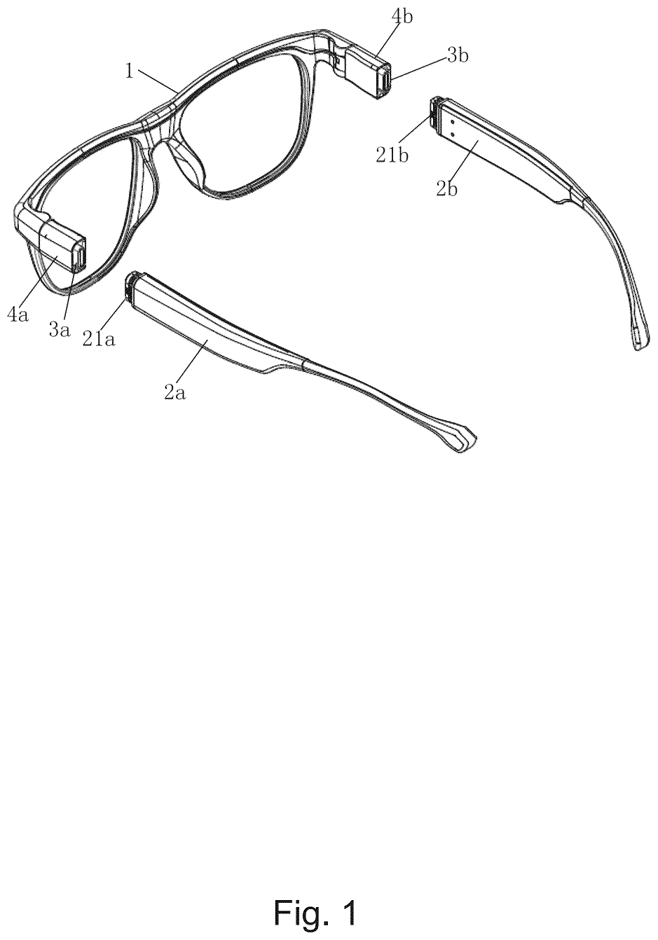

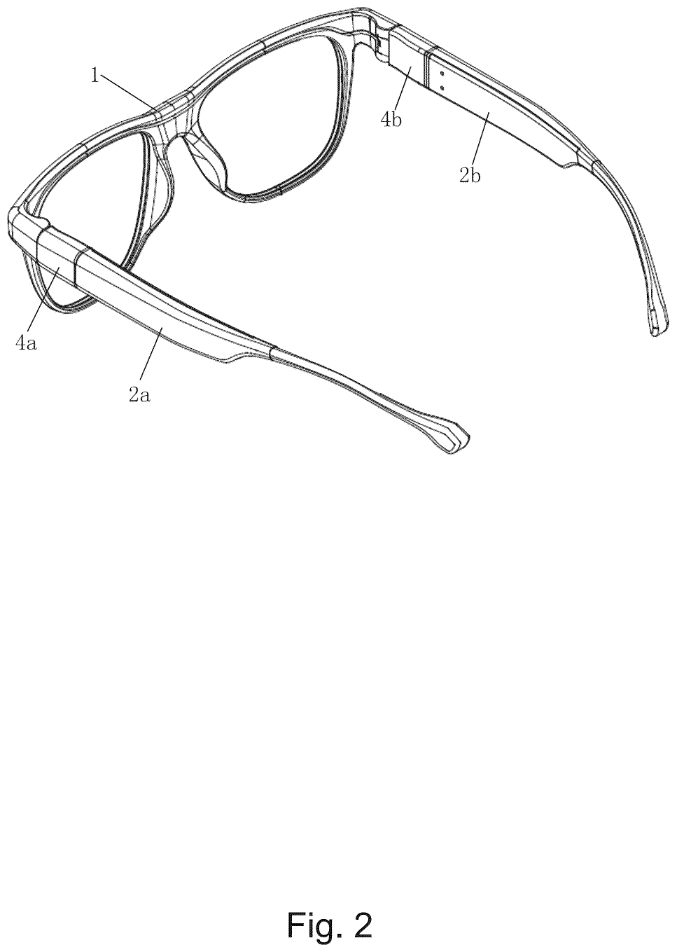

Referring to FIG. 1 and FIG. 2, an embodiment of a pair of smart glasses is shown, which includes a first component, a second component, a third component and a connecting assembly. The first component is a frame 1 of the smart glasses, the second component is a temple 2 (such as left temple 2a) of the smart glasses, and the third component is another temple 2 (such as right temple 2b) of the smart glasses.

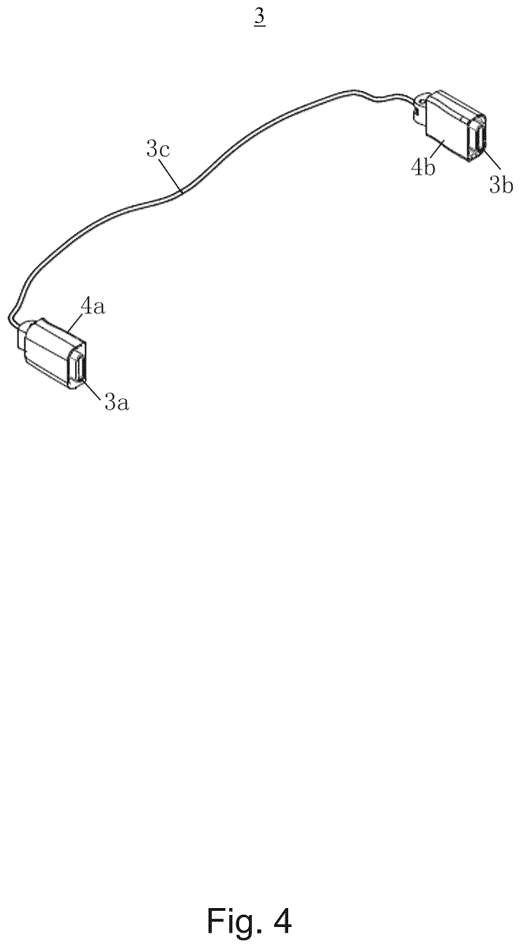

Referring to FIG. 4, the connecting assembly 3 includes a connecting wire 3c, a first smart hinge 4a configured with a first connector 3a and a second smart hinge 4b configured with a second connector 3b. Referring to FIG. 1, a connecting end (such as a front end) of the left temple 2a is provided with a left connector 21a matching with the first connector 3a of the first smart hinge 4a; and a connecting end (such as a front end) of the right temple 2b is provided with a right connector 21b matching with the second connector 3b of the second smart hinge 4b. Another ends (such as rear ends) of the left temple 2a and right temple 2b are configured to be worn on the ears of a human body during use.

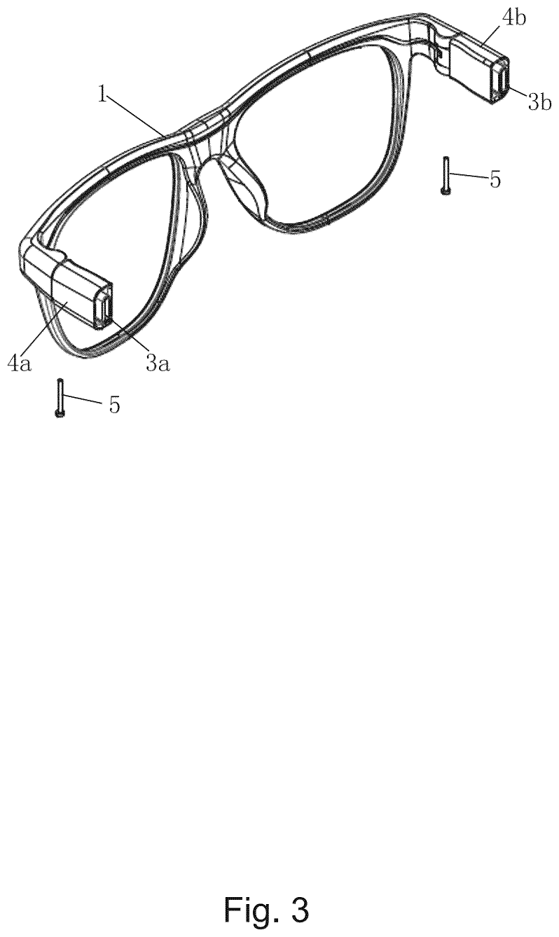

Referring to FIG. 3, first ends of the first smart hinge 4a and the second smart hinge 4b are respectively hinged to two opposite ends (such as left and right ends) of the frame 1 through a mounting shaft, such as a screw rod 5. The first smart hinge 4a is connected to the left temple 2a by plugging of the connecting end of the left temple 2a into the second end of the first smart hinge 4a. The second smart hinge 4b is connected to the right temple 2b by plugging of the connecting end of the right temple 2b into the second end of the second smart hinge 4b. The first smart hinge 4a and the left temple 2a, and/or, the second smart hinge 4b and the right temple 2b, are fixed together by a snap structure.

Since the smart hinges 4a, 4b are detachably connected to the temples 2a, 2b by plugging, it is easy to disassemble the frame 1, the left temple 2a and the right temple 2b, which is conducive to improving the production yield and reducing the maintenance time of the smart glasses. Further, the frame 1 and the temples, including the left temple 2a and the right temple 2b, of different generations or styles can be interchanged, the user can upgrade their smart glasses with the latest frame 1 and temples. For example, the temple may be replaced from the first generation to the second generation or third generation while the frame is unchanged. The user may upgrade their smart glasses with the latest temples without using prescription lenses to replace the frame. The user also may replace different types of frames while use the same temples. That is, the temple can be equipped with fashionable blue light frames at work, or be equipped with sun frames at sports or outdoors. The product functions can be switched flexibly.

It can be understood that the first connector 3a and the second connector 3b of the above-mentioned connecting assembly 3 may be the same type or may be different in types. For example, as shown in FIG. 4, the first connector 3a and the second connector 3b both are USB Type-B connectors. Alternatively, the first connector 3a may be a USB Type-B connector, while the second connector 3b may be a USB Type-C connector, an apple lightning connector, or other types of connectors.

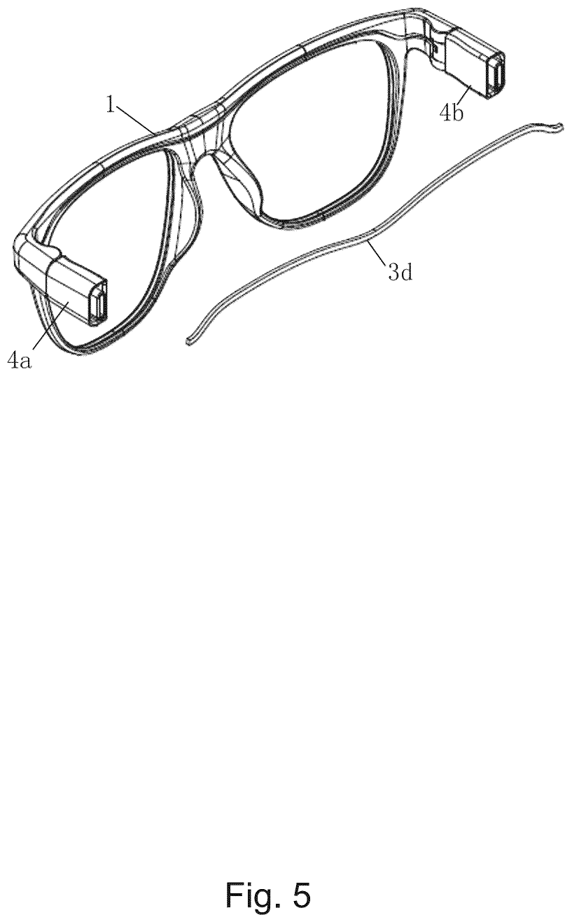

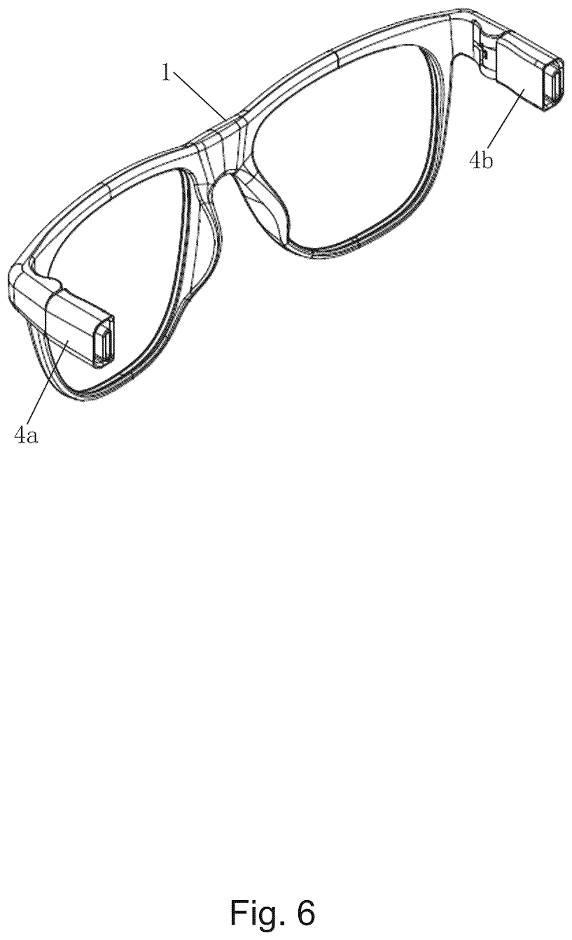

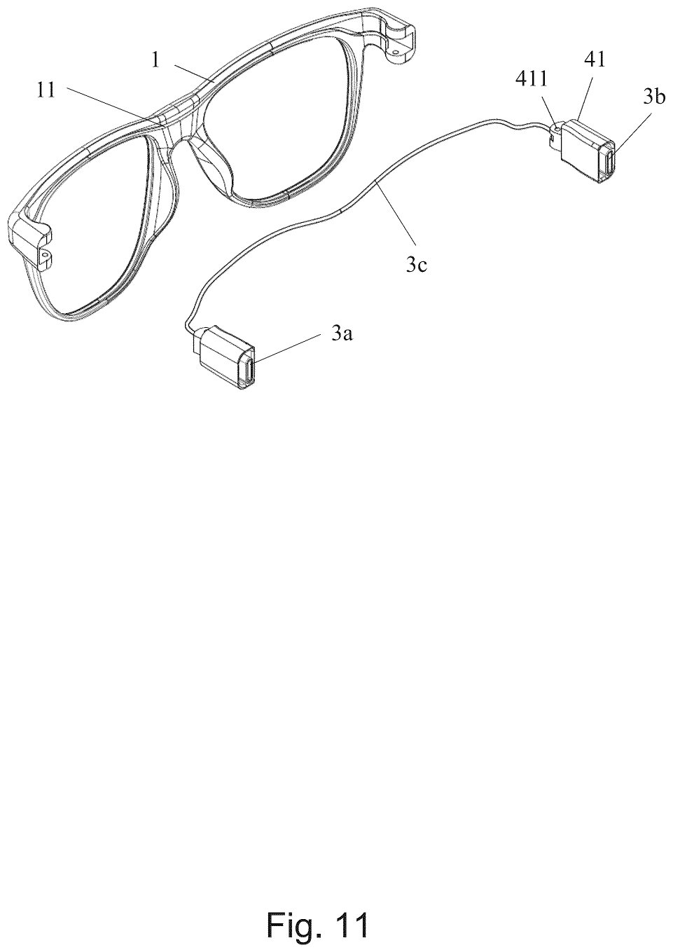

Referring to FIG. 11, the frame 1 of this embodiment is provided with an elongated slot 11, which extends through the left and right ends of the frame 1. The connecting wire 3c is accommodated in the elongated slot 11. In an embodiment, the connecting wire 3c may be fixed in the elongated slot 11. In another embodiment, the connecting wire 3c may be movable in the elongated slot 11. The elongated slot 11 is covered with a flexible decorative strip 3d, thus the connecting wire 3c is hidden in the frame 1 (as shown in FIGS. 5-6).

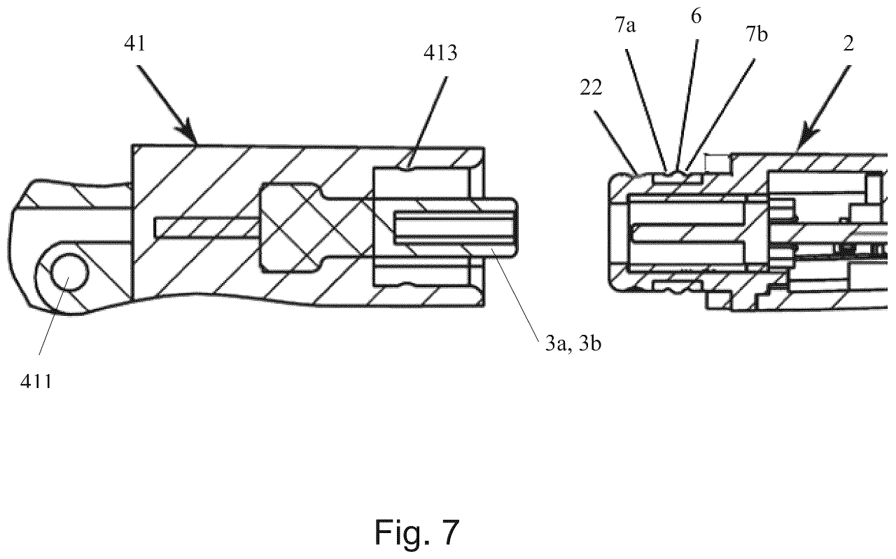

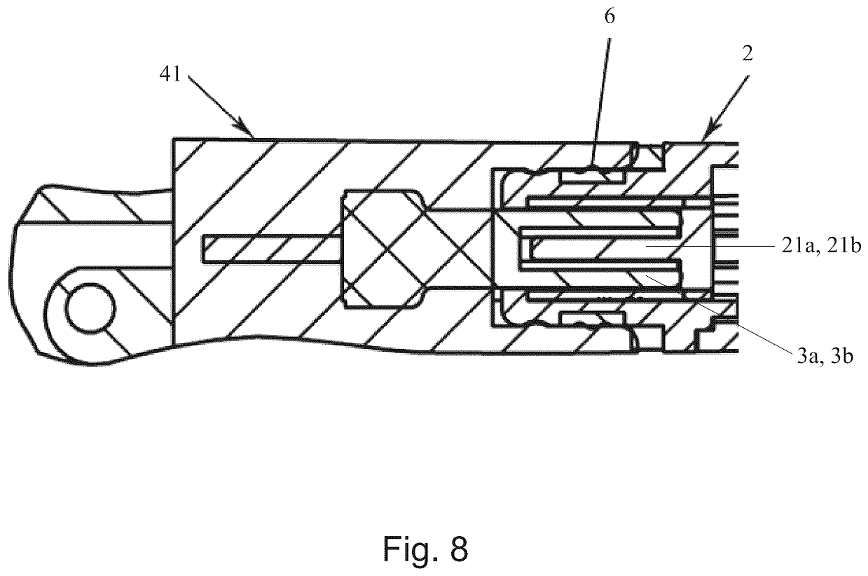

Referring to FIG. 7 and FIG. 8, in order to enhance the water-proof and dust-proof performance of the smart glasses, an outer circumferential surface of the connecting end of the temple, including the left temple 2a and/or the right temple 2b, is provided with a protruding ring 6. When the connecting end of the temple 2a, 2b is plugged into the second end of the smart hinge 4a, 4b, an inner circumferential face of the second end of the smart hinge 4a, 4b abuts against the sealing ring 6.

Further, the outer circumferential surface of the connecting end of the temple 2a, 2b is provided with two anticollision grooves 7a, 7b at two opposite sides of the protruding ring 6, respectively. When the temple 2a, 2b is connected to the corresponding smart hinge 4a, 4b, the sealing ring 6 is pressed to deform, so that engages into the adjacent anticollision grooves 7a, 7b, thereby preventing the sealing ring 6 from squeezing the temple 2a, 2b.

In this embodiment, the protruding ring 6 and the anticollision grooves 7a, 7b may be provided with a sleeve made of elastic materials, such as rubber. An annular groove may be defined in the outer circumferential surface of the connecting end of the temple 2a, 2b to receive the sleeve therein. Preferably, the sleeve is connected to the connecting end of the temple 2a, 2b in an un-detachable manner.

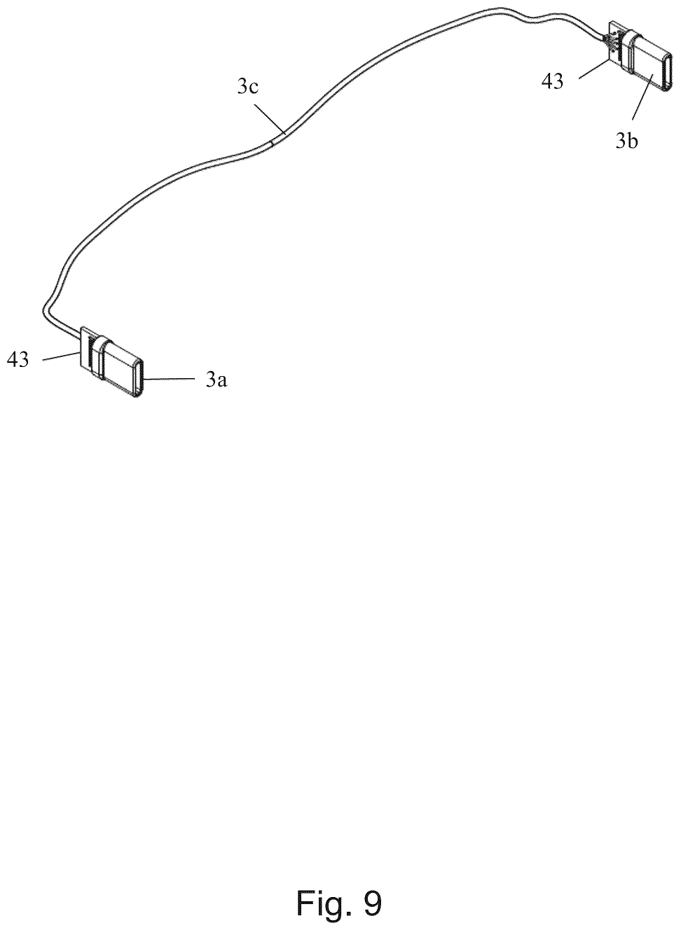

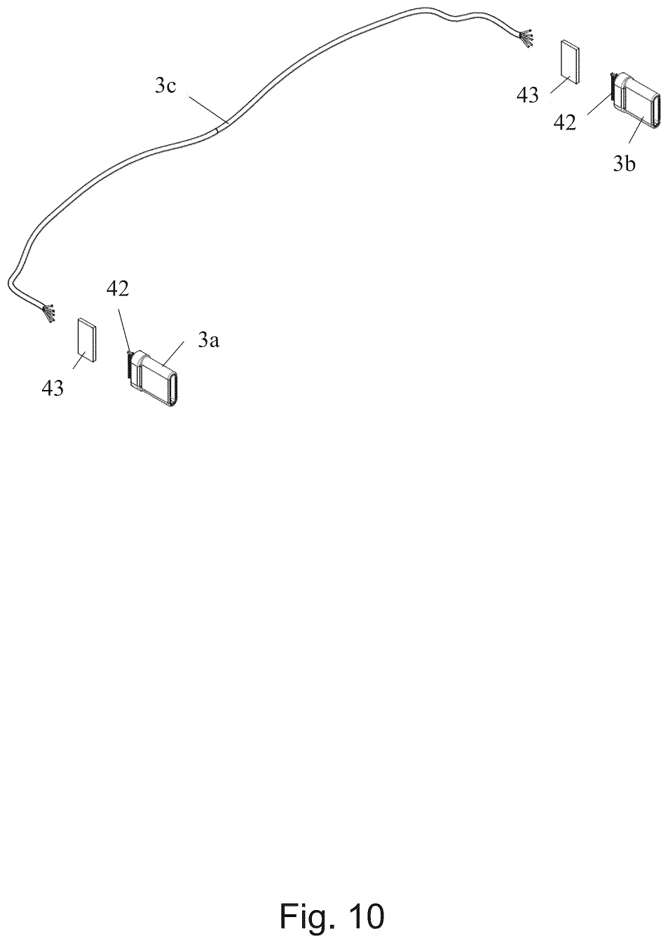

Referring to FIG. 9 to FIG. 11, the smart hinge 4a or 4b further includes an insulating shell 41, a circuit board 42 and a substrate 43. An end of the connecting wire 3c is welded to the substrate 43, and the circuit board 42 is installed in the insulating shell 41 and welded to the substrate 43. The first connector 3a or the second connector 3b is mounted in and located at an end of the insulating shell 41, and electrically connected to the circuit board 42.

A connecting hole 411 is defined in another end of the insulating shell 41, and the first end of the insulating shell 41 is hinged to the frame 1 by the screw rod 5 which extends into the connecting hole 411 of the insulating shell 41. Referring to FIG. 7 and FIG. 8, the end of the insulating shell 41 with the connector 3a, 3b is provided with a latching portion 413, and the outer circumferential surface of the connecting end of the temple 2a, 2b is provided with a latching groove 22, wherein the latching portion 413 engages into the latching groove 22 for reinforcement of the connecting end of the temple 2a, 2b and the insulating shell 41. The latching portion 413 and latching groove 22 cooperate with each other to form the snap structure, thereby connecting the temple 2a, 2b to the smart hinge 4a, 4b by snap-fit.

As shown in FIG. 7, in this embodiment, the insulating shell 41 defines a chamber around the connector 3a, 3b, and the latching portion 413 may be an internal latching element which protrudes inwardly from an inner circumferential wall of the insulating shell 41 surrounding the chamber.

Further, the insulating shell 41 includes a plastic shell body and a cover. The circuit board 42 is located in a mounting groove defined in the shell body, and the cover covers the mounting groove. A gap between the circuit board 42 and the mounting groove is filled with water-proof glue, so that water can be prevented from entering the temple from the smart hinge.

When the smart hinge 4a, 4b and the temple 2a, 2b are connected by plugging, the second end of the temple 2a, 2b is inserted into the chamber of the insulating shell 41, making the connector 21a, 21b at the second end of the temple 2a, 2b be inserted into the connector 3a, 3b to realize electric connection between the smart hinge 4a, 4b and the temple 2a, 2b. Due to the different types of connectors provided on the temple, the shapes of interfaces for inserting of the smart hinge are also different. The latching portion 413 in the insulating shell 41 can be made in different forms according to specific requirements.

An MCU is set inside the temple 2a, 2b, and wireless communication modules are set inside the temples 2a, 2b and the smart hinges 4a, 4b, respectively. The wireless communication module inside the smart hinge 4a, 4b communicates with the MCU or a mobile phone, and the MCU communicates with the mobile phone through the wireless communication module in the temple 2a, 2b.

In one embodiment, the connectors 21a, 21b at the connecting ends of the left temple 2a and the right temple 2b are USB type-B connectors, USB type-C connectors, or apple lightning connectors. The connecting wire 3c is an electric cable, and received in the elongated slot 11 defined in the frame 1, and the first connector 3a at the left end of the frame 1 and the second connector 3b at the right end of the frame 1 are connected together by the electric cable.

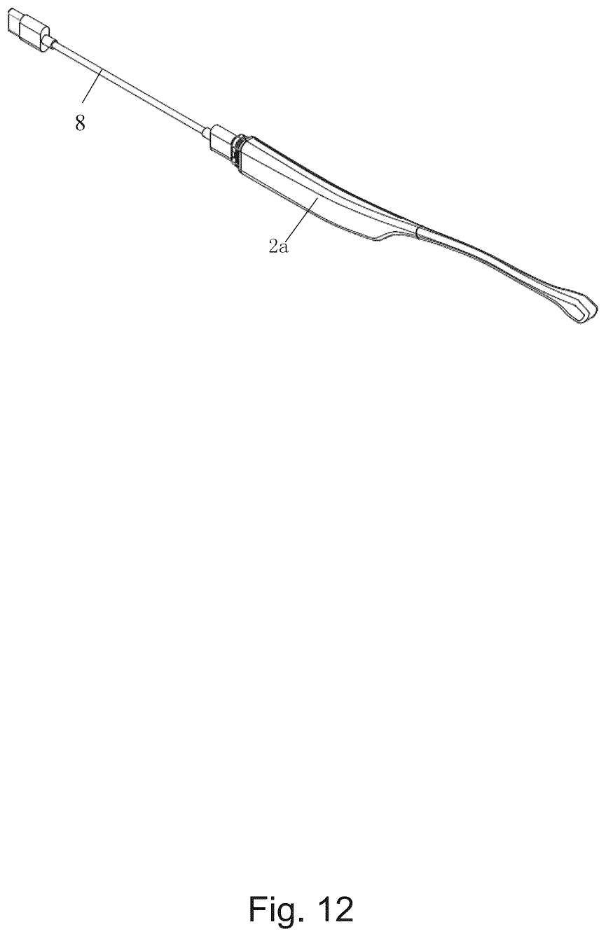

Both the left temple 2a and the right temple 2b are provided with rechargeable batteries that are electrically connected to the connectors at their connecting ends. Referring to FIG. 12, when the rechargeable batteries need to be charged, the left temple 2a and/or the right temple 2b can be disassembled from the connecting assembly and then the connector of the left temple 2a and/or the right temple 2b can be connected to a corresponding type of external charging cable 8, thereby realizing charging the rechargeable batteries.

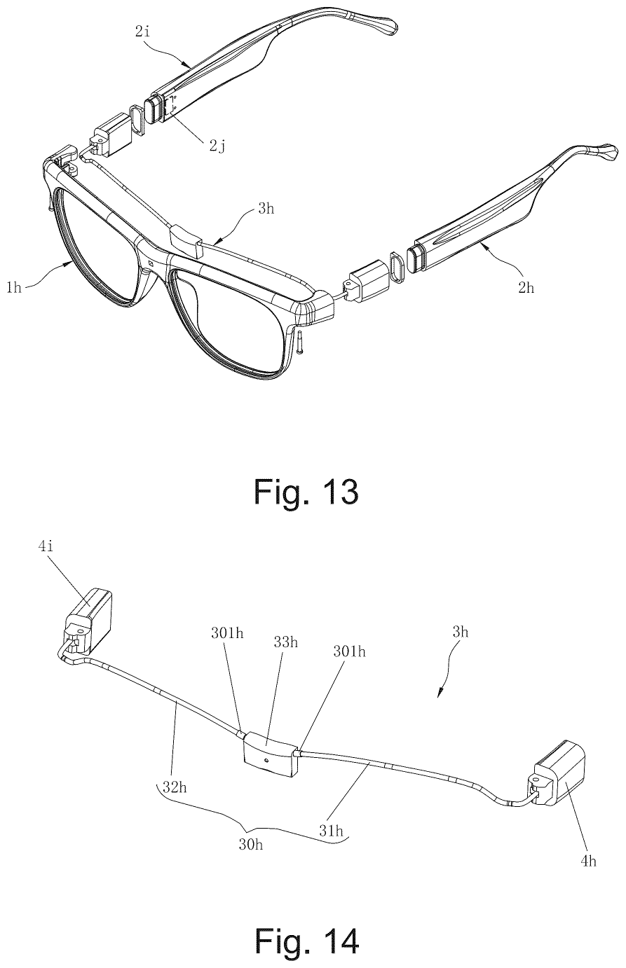

Referring to FIG. 13, a pair of smart glasses according to an alternative embodiment of the present application is shown. Similar to the previous embodiment, the smart glasses includes a frame 1h, a left temple 2h, a right temple 2i, and a connecting assembly 3h that is configured to connect the frame 1h, the left temple 2h, and the right temple 2i together in a detachable manner. In this embodiment, as shown in FIG. 14, the connecting assembly 3h includes a connecting wire 30h, a sensor unit 33h, a first hinge 4h, and a second smart hinge 4i.

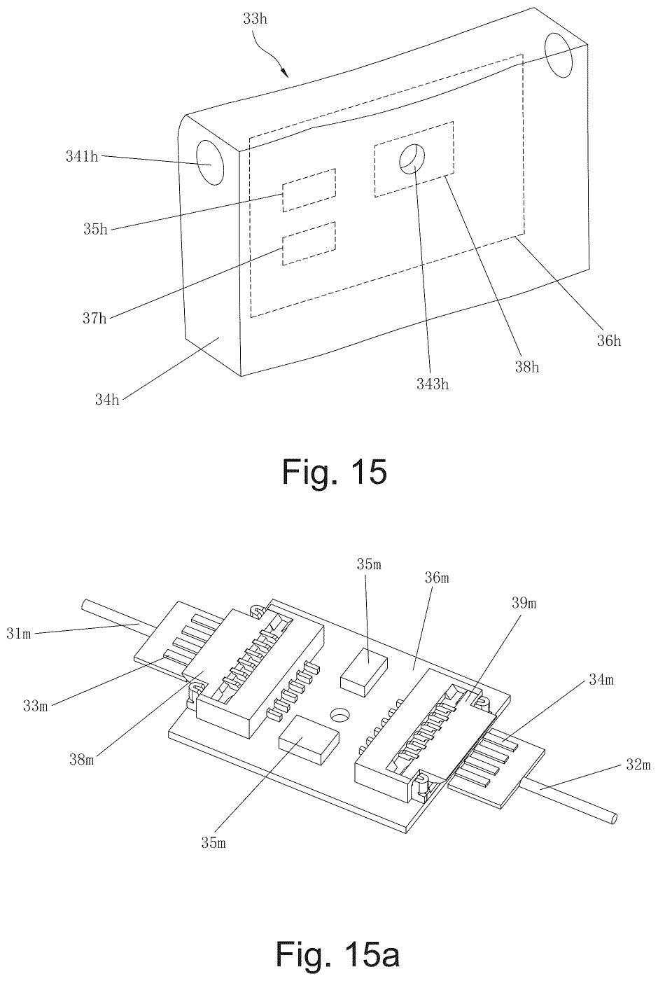

The connecting wire 30h is fixed onto the frame 1h, the first and second smart hinges 4h, 4i are provided at two opposite ends of the connecting wire 30h for electrically connecting the left and right temples 2h, 2i, respectively. As shown in FIG. 15, the sensor unit 33h includes a mechanical housing 34h and at least one sensor 35h accommodated inside the mechanical housing 34h, wherein the sensor 35h is electrically connected to the first and second smart hinges 4h, 4i through the connecting wire 30h, so as to send detected information to the processors inside the first smart hinge 4h, the second smart hinge 4i, the left temple 2h, and/or the right temple 2i for processing.

The sensor 35h is set inside the mechanical housing 34h, and electrically connected to the connecting wire 30h in a detachable manner. In practical applications, the connecting wire 30h may be electrically connected to the sensor 35h through welding, plugging, pressing, connectors, and etc.

When the connecting wire 30h is electrically connected to the sensor 35h by plugging, the mechanical housing 34h is provided with a data transmission interface 341h. In this case, a circuit board 36h is set inside the mechanical housing 34h, the sensor 35h is connected to the circuit board 36h by welding, and the data transmission interface 341h is also connected to the circuit board 36h by welding. An end of the connecting wire 30h is provided with a data transmission connector 301h, which is inserted into the data transmission interface 341h to achieve electrical connection, as shown in FIG. 13.

Furthermore, as shown in FIG. 14, the connecting wire 30h includes a first segment 31h and a second segment 32h. One end of the first segment 3 1h is electrically connected to the first smart hinge 4h, and another end of the first segment 31h is plugged into a corresponding data transmission interface 341h of the mechanical housing 34h through its data transmission connector 301h. One end of the second segment 32h is electrically connected to the second smart hinge 4i, and another end of the second segment 32h is plugged into another corresponding data transmission interface 341h of the mechanical housing 34h through its data transmission connector 301h.

In other embodiments, as shown in FIG. 15a, the connecting wire includes a first segment 31m and a second segment 32m. One end of the first segment 31m is electrically connected to the first smart hinge 4h, and another end of the first segment 31m is provided with a first gold finger 33m. One end of the second segment 32m is electrically connected to the second smart hinge 4i, and another end of the second segment 32m is provided with a second gold finger 34m.

The sensor unit includes a circuit board 36m with sensor(s) 35m fixed thereon, wherein two opposite edges of the circuit board 36m are respectively provided with two edge connectors 38m, 39m which are configured as sockets. When assembled, the first gold finger 33m is inserted into one corresponding edge connector 38m, and the second gold finger 34m is inserted into the other edge connector 39m, thereby achieving mechanical and electrical connection of the connecting wire and the sensors 35m.

When the connecting wire 30h is electrically connected to the sensor 35h by pressing, an opening may be defined in the mechanical housing 34h. In this case, a circuit board is set inside the mechanical housing 34h, and the sensor 35h is connected to the circuit board by welding. Two elastic conductive sheets are set inside the opening, being opposite to and spaced from each other. The two elastic conductive sheets are connected to the circuit board by welding. One end of the connecting wire is clamped between the two elastic conductive sheets to achieve electrical connection between the connecting wire 30h and the sensor 35h.

The mechanical housing 34h is further provided with a wireless communication unit 37h therein. The data detected by the sensor 35h can be transmitted to the processor through the wireless communication unit 37h. The processor may be set in the first smart hinge 4h, the second smart hinge 4i, the left temple 2h, or the right temple 2i. In FIG. 13, it is illustrated that a processor 2j is set in the right temple 2i.

The connecting assembly 3h may be further provided with an indicator light 38h, wherein the indicator light 38h and the sensor 35h are packaged as an integral structure. The indicator light 38h and the sensor 35h are packaged onto the circuit board 36h installed inside the mechanical housing 34h. As shown in FIG. 15, the mechanical housing 34h defines a transparent hole 343h at a position thereof corresponding to the indicator light 38h.

There may be one or multiple sensors 35h inside the mechanical housing 34h, and the sensors 35h may be in different types, such as being light sensor, distance sensor, gas sensor, inertial sensor, sound sensor, and etc.

In this embodiment, the first end of the first smart hinge 4h is used to hinge with the frame 1h, and the second end of the first smart hinge 4h is used to plug into the left temple 2h. The second end of the first smart hinge 4h and an end face of the left temple 2h are provided with matching electrical contacts 4j. When the second end of the first smart hinge 4h is plugged into the left temple 2h, electrical and mechanical connection between the first smart hinge 4h and the left temple 2h can be realized. The left temple 2h can rotate relative to the frame 1h and can be detached from the first smart hinge 4h, thereby separating the left temple 2h from the frame 1h.

The first end of the second smart hinge 4i is used to hinge with the frame 1h, and the second end of the second smart hinge 4i is used to plug into the right temple 2i. Similarly, the second end of the second smart hinge 4i and an end face of the right temple 2i are equipped with matching electrical contacts 4j. When the second end of the second smart hinge 4i is plugged into the right temple 2i, electrical and mechanical connection between the second smart hinge 4i and the right temple 2i can be realized. The right temple 2i can rotate relative to the frame 1h and can be detached from the second smart hinge 4i, thereby separating the right temple 2i from the frame 1h.

Due to the plug-in connection between the left temple 2h/right temple 2i and the frame 1h, when the left temple 2h and/or right temple 2i need to be upgraded, they can be replaced with temple(s) integrated with different functional modules.

It should be noted that, in addition to using plug-in connections, the smart hinges and the temples can also be detachably connected by other means, such as threaded connection, snap-fit connection, and etc. In addition, in addition to using detachable connection methods, hinges, flexible connecting members, and etc. may also be used to connect the smart hinge and the temple fixedly; or, the smart hinge and the temple may be formed as an integrated structure. When the smart hinge and the temple are configured as an integrated structure, a metal wire may be provided in the smart hinge and the temple to achieve telecommunication connection between the smart hinge and electronic components in the temple.

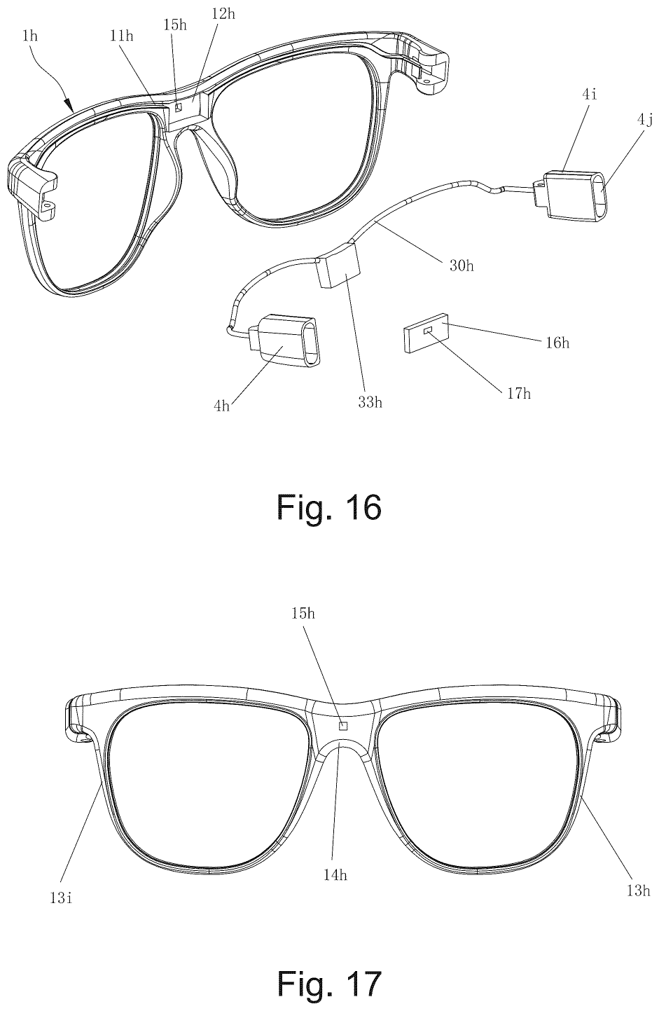

Referring to FIG. 16, the frame 1h is provided with a receiving groove 12h, and the mechanical housing 34h with sensors 35h received therein is installed in the receiving groove 12h in a detachable manner. Specifically, the shape and size of the mechanical housing 34h in this embodiment match the shape and size of the receiving groove 12h. The mechanical housing 34h is fixed in the receiving groove 12h by interference fitting.

An inner side of the frame 1h is further provided with an elongated slot 11h being communicated with the receiving groove 12h, and the connecting wire 30h is embedded in the elongated slot 11h. In practical applications, a cover 16h may be placed on the open side of the receiving groove 12h, and a flexible decorative strip (referring to the strip 3d of the first embodiment) in the form of a strip may be placed on the elongated slot 11h. This not only ensures the appearance of the product, but also seals the receiving groove 12h and elongated slot 11h, thereby avoiding water or dust from contacting the sensor 35h and affecting its operation.

Furthermore, the sensor(s) 35h may include a distance sensor and/or a light sensor and/or a camera sensor, and the open side of the receiving groove 12h faces the inner side of the frame 1h. Please refer to FIG. 17, the frame 1h includes two receiving parts 13h, 13i and a bridge 14h located between the two receiving parts 13h, 13i. The outer side of the bridge 14h has an external aperture 15h provided at a position corresponding to the receiving groove 12h. The distance sensor detects the distance information of the target object in the peripheral environment through the external aperture 15h; the light sensor detects the ambient light information of the target object in the peripheral environment through the external aperture 15h; and the camera sensor captures image of the target object in the peripheral environment through the external aperture.

Furthermore, the sensor(s) 35h may include a temperature sensor, and the cover 16h of the receiving groove 12h has an internal aperture 17h. The temperature sensor detects the user's body temperature through the internal aperture 17h. As the internal aperture 17h is directly facing and close to the human body, the detected body temperature is accurately.

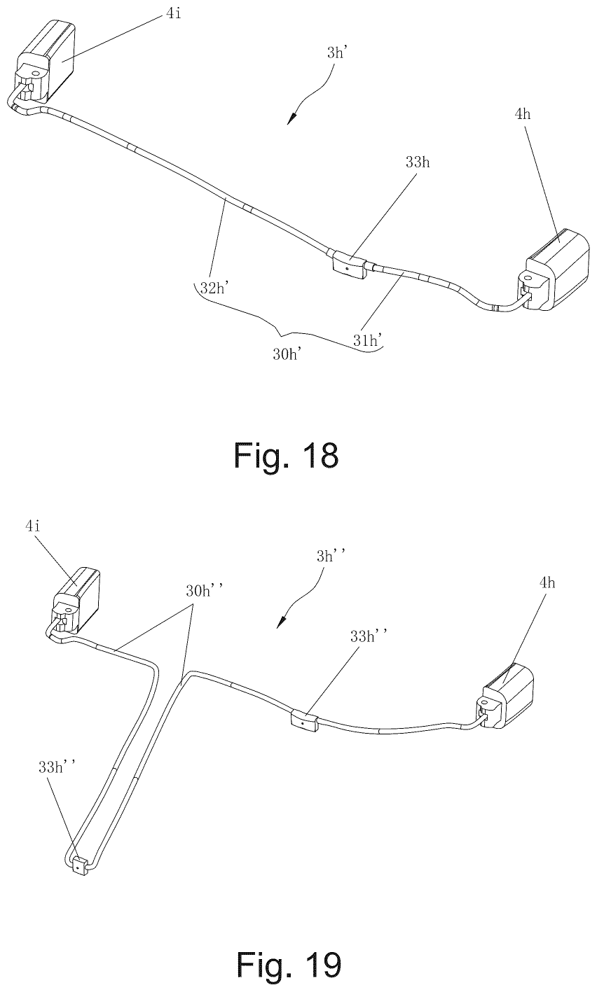

As shown in FIG. 18, in other embodiments, the connecting assembly 3h′ includes a connecting wire 30h′, a sensor unit 33h, a first smart hinge 4h, and a second smart hinge 4i. Differently, a first segment 31h′ of the connecting wire 30h′ between the sensor unit 33 and the first smart hinge 4h is shorter than a second segment 32h′ of the connecting wire 30h′ between the sensor unit 33 and the second smart hinge 4i′, and thus the sensor unit 33h is close to the first hinge 4h and away from the second smart hinge 4i. In this case, the sensor unit 33h may be fixed onto the left receiving part 13h of the frame 1h. Alternatively, the sensor unit 33h may be configured to be close to the second smart hinge 4i and fixed onto the right receiving part 13i of the frame 1h.

In other embodiments, the connecting assembly may be configured with multiple sensor units which are spaced from each other and connected together by the connecting wire. For example, as shown in FIG. 19, in an embodiment, the connecting assembly 30h″ is configured with two sensor units 33h″, one of which may be fixed onto an inner edge of the left receiving part 13h, and the another may be fixed onto an upper edge of the right receiving part 13i of the frame 1h. In this case, a connecting wire 30h″ for connecting the two sensor units 33h″ includes three segments.

In other embodiments, the connecting assembly may be configured with multiple sensor units, wherein one of the sensor units may be fixed onto the receiving part; and/or, another one of the sensor units may be fixed onto the bridge of the frame. In addition, a number of the sensor unit(s) on each part of the frame may be one or multiple, and the specific positions of the sensor unit(s) on the frame may be changed according to need.

In summary, embodiments of the present application sets the space and structure required for installing the sensors on the connecting wire of the connecting assembly, so only the structure for fixing the connecting wire needs to be set on the frame. It can be seen that these embodiments of the present application simplify the structure and manufacturing process of the frame or the temples by integrating the sensor unit and their related installation structures required for smart glasses onto the connecting wire.

The above merely provides the preferred embodiments of the present disclosure, which is illustrative, rather than restrictive, to the present disclosure. However, it should be understood by those skilled in the art that, many variations, modifications even substitutions that do not depart from the spirit and scope defined by the present disclosure, shall fall into the extent of protection of the present disclosure.

What is claimed is:

1. A connecting assembly, configured for setting on a frame of a pair of smart glasses to electrically connect left and right temples of the smart glasses, comprising:
a connecting wire being configured with first and second smart hinges at two opposite ends thereof, respectively, the first smart hinge being configured for electrically connecting the left temple, and the second smart hinge being configured for electrically connecting the right temple; and
a sensor unit being provided on the connecting wire and electrically connected to the first smart hinge and/or the second smart hinge through the connecting wire.

2. The connecting assembly according to claim 1, wherein the sensor unit is electrically connected to the connecting wire in a detachable manner.

3. The connecting assembly according to claim 2, wherein the sensor unit comprises at least one sensor and a mechanical housing accommodating the at least one sensor therein.

4. The connecting assembly according to claim 3, wherein the connecting wire is electrically connected to the at least one sensor through welding, plugging, pressing or an electrical connector.

5. The connecting assembly according to claim 3, wherein a data transmission interface is provided on the mechanical housing and electrically connected to the at least one sensor, and a data transmission connector is provided at an end of the connecting wire and electrically connected to the data transmission interface through plugging.

6. The connecting assembly according to claim 5, wherein the connecting wire comprises a first segment and a second segment, each of the first and second segments is provided with one data transmission connector, and the mechanical housing is provided with two data transmission interfaces;
one end of the first segment is electrically connected to the first smart hinge, and another end the first segment is connected to the mechanical housing; and
one end of the second segment is electrically connected to the second smart hinge, and another end of the second segment is connected to the mechanical housing.

7. The connecting assembly according to claim 3, wherein a wireless communication unit is provided inside the mechanical housing to transmit detected data of the sensor to a processor set in one of the first smart hinge, the second smart hinge, the left temple and the right temple.

8. The connecting assembly according to claim 1, wherein the sensor unit comprises a sensor and/or an indicator light packaged as an integrated structure.

9. The connecting assembly according to claim 1, wherein the sensor unit comprises at least one of a light sensor, a distance sensor, a gas sensor, an inertial sensor, a camera sensor and a sound sensor.

10. The connecting assembly according to claim 2, wherein the sensor unit comprises a circuit board and at least one sensor fixed on the circuit board, and two edge connectors are provided at two opposite edges of the circuit board, respectively; and
wherein the connecting wire comprises a first segment and a second segment, a first gold finger is provided on the first segment and inserted into one of the two edge connectors, and a second gold finger is provided on the second segment and inserted into another one of the two edge connectors.

11. A smart glasses comprising a frame, a left temple, a right temple and the connecting assembly according to claim 1, wherein the connecting wire of the connecting assembly is fixed onto the frame, and the left temple and the right temple are electrically connected through the connecting wire.

12. The smart glasses according to claim 11, wherein the frame is provided with a receiving groove, and the sensor unit is detachably installed in the receiving groove.

13. The smart glasses according to claim 12, wherein the frame comprises two accommodating parts and a bridge connected between the two accommodating parts, the receiving groove is defined at an inner side of the bridge, and an outer side of the bridge is provided with an external aperture at a position corresponding to the receiving groove; and
the sensor unit comprises a distance sensor, wherein the distance sensor detects a distance information of a target object in the peripheral environment through the external aperture.

14. The smart glasses according to claim 12, wherein the frame comprises two accommodating parts and a bridge connected between the two accommodating parts, the receiving groove is defined at an inner side of the bridge, and an outer side of the bridge is provided with an external aperture at a position corresponding to the receiving groove; and
the sensor unit comprises a light sensor, wherein the light sensor detects an ambient light information of the target object in the peripheral environment through the external aperture.

15. The smart glasses according to claim 12, wherein the frame comprises two accommodating parts and a bridge connected between the two accommodating parts, the receiving groove is defined at an inner side of the bridge, and an outer side of the bridge is provided with an external aperture at a position corresponding to the receiving groove; and
the sensor unit comprises a camera sensor, wherein the camera sensor captures image of a target object in the peripheral environment through the external aperture.

16. The smart glasses according to claim 12, wherein the sensor unit comprises a temperature sensor, an open side of the receiving groove faces an inner side of the frame, and a cover is fixed onto the open side of the receiving groove, the cover is provided an internal aperture, and the temperature sensor detects an user's body temperature through the internal aperture.

17. The smart glasses according to claim 11, wherein
one end of the first smart hinge is configured to hinge with the frame, and another end of the first smart hinge is configured to achieve electrical connection with the left temple after being plugged in the left temple; and
one end of the second smart hinge is configured to hinge with the frame, and another end of the second smart hinge is configured to achieve electrical connection with the right temple after being plugged in the right temple.

18. The smart glasses according to claim 11, wherein
one end of the first smart hinge is configured to hinge with the frame, and another end of the first smart hinge is integrally connected to the left temple; and
one end of the second smart hinge is configured to hinge with the frame, and another end of the second smart hinge is integrally connected to the right temple.
